(19) United States
(12) Patent Application Publication
(10) Pub. No.: US 2010/0047616 A1
(43) Pub. Date: Feb. 25, 2010

(54) Wire Feedstock and Process for Producing the Same

(75) Inventor: David J. Urevich, Wentzville, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: ARCMELT COMPANY, LC., Bridgeton, MO (US)

(21) Appl. No.: 12/519,477

(22) PCT Filed: Dec. 17, 2007
(86) PCT No.: PCT/US2007/087752

§ 371 Date: Jun. 16, 2009

Related U.S. Application Data
(60) Provisional application No. 60/870,437, filed on Dec. 18, 2006.

(51) Int. Cl. B32B 15/02; B32B 15/20; B21C 37/04

(52) U.S. Cl. 428/650; 428/680; 428/681; 72/278

(57) ABSTRACT

A wire (2) for use as a feedstock in metal spraying and in welding contains two components (4, 6) formed from different metals, with the components being in face-to-face contact along a convoluted interface (8) that extends throughout the interior of the wire. This leaves the distribution of the two metals in generally uniform throughout the cross section of the wire. To produce the wire, two flat strips (22, 22 or 30, 32) of the different metals are provided, with the strips (22, 32) of the second component overlying the strips (20, 30) of the first component to form a laminate (24, 34). Then the laminate is deformed into a U-shaped configuration with the second strip being confined within the first strip. Next the ends of the U-shaped laminate are turned inwardly. The resulting configuration, which has a convoluted interface, is drawn through a die to reduce its cross-sectional size and to densify it.

### CROSS-REFERENCE TO RELATED APPLICATIONS

This application derives and claims priority from U.S. provisional application 60/870,437 filed 18 Dec. 2006, which is incorporated herein by reference.

### TECHNICAL FIELD

This invention relates in general to wire feedstock for thermal spraying, welding and the like, and more particularly to wire feedstock having precisely controlled constituents and a process for manufacturing the same.

### BACKGROUND ART

Deposited aluminides, which are intermetallic alloys of aluminum and other metals, can withstand high temperatures in corrosive environments, and as a consequence they find use as overlays and protective coatings on other metals, such as steel, that are readily attacked in such corrosive environments. Most often they are applied to a steel substrate by thermal spraying, particularly spraying in which the heat source is an arc struck between two electrodes. Indeed, the feedstock, which takes the form of two wires, can form the electrodes. Because both wires are consumed to provide the metal that is sprayed onto the substrate, the wires are small in cross section, often having a diameter on the order of 3/32 or ⅛ inch.

Nickel aluminides and to a lesser measure, iron aluminides, find widespread use in weld overlays and coatings. The typical wire for the wire electrodes that produce aluminides for weld overlays and coatings has a nickel or iron case and a core composed of aluminum powder. The arc melts both and they unite in an exothermic reaction. The exothermic reaction elevates the temperature of the metals and contributes to the melting of them. Rapid solidification of the metal on the steel substrate forms the aluminide, and this assures a better bond with the substrate.

But the nickel or iron of the case does not mix well with the aluminum of the core. As a consequence, the coating contains excessive free nickel or iron and excessive free aluminum and not enough aluminide. In short, the aluminide phase of the coating is deficient.

Apart from that, aluminum powder has an enormous surface area along which oxygen reacts with the aluminum to form aluminum oxide, and aluminum oxide detracts from the uniformity and integrity of the coating by imparting aluminum oxide inclusions to the coating. Indeed, it contributes to a diminished production of aluminide.

Other types of feedstock wire are equally deficient. For example, a solid wire alloy of nickel and aluminum when fed into an arc or other heat source to produce a thermal spray, results in no exothermic reaction and no aluminide is deposited on the substrate. Some nickel-aluminum wires have an aluminum wire core with a nickel case around it. From a practical standpoint, this wire cannot be produced in diameters less than about ⅛ inch, and thus it is not suitable for twin arc spraying, which requires diameters at least that small for the two wires. Moreover, the arc tends to attach to the more conductive aluminum, and this detracts from the production of aluminide. Some wires are tubular, but these wires contain oxygen, which detracts from the uniformity and quality of the aluminide coating.

Alloys have other deficiencies that sometimes render them unsuitable for wire feedstock, whether the feedstock be for spraying or welding or for some other procedure. The alloy of nickel and aluminum serves as an example. This alloy can contain no more than about 10% aluminum by volume, since that is as much as the nickel will accept. But some procedures, such as the deposit of aluminides by thermal spraying, demand feedstock containing a greater amount of aluminum. The same holds true for wire feedstock containing alloys other metals such as nickel and copper, known as Monel metal, which can contain no more than about 35% copper, but more copper may be desirable for some procedures.

### BRIEF DESCRIPTION OF THE DRAWINGS

FIG. 1 is a cross-sectional view of a wire produced in accordance with the present invention for use as a feedstock in thermal spraying that provides an aluminide coating, there being a grid superimposed on the cross section to show the distribution of nickel and aluminum in the wire;

FIG. 2 is a perspective view of two strips of metal used to form the wire;

FIGS. 3-5 are cross-sectional views of the strips during successive deformations of them to prepare them for a final reduction in size; and

FIG. 6 is a perspective view of an aluminum-clad nickel strip that may also be used to form the wire.

Corresponding reference numerals indicate corresponding parts throughout the several figures of the drawings.

### BEST MODES FOR CARRYING OUT THE INVENTION

A wire 2 (FIG. 1) for use as a consumable electrode in a thermal spraying apparatus or for use as simply a feedstock for an arc, combustion or plasma spraying or welding apparatus, includes a nickel component 4 and an aluminum component 6, with the components 4 and 6 being in face-to-face contact throughout the cross-section of the wire 2. The nickel component 4 forms the exterior of the wire 2 and exceeds the aluminum component, both in weight and surface area. Within the wire 2 the two components 4 and 6 are in face-to-face contact along convoluted interfaces 8 that are spaced somewhat uniformly across the wire 2, typically without any bonding along the interfaces 8. When a grid 10 having squares approximately the size of the combined thickness of the nickel component 4 and the aluminum component 6 at any interface 8 is superimposed on a cross section of the wire 2, each square of the grid 10 will possess nickel and aluminum in somewhat the same volumetric proportions. The nickel component 4 may be an alloy of nickel and likewise the aluminum component 6 may be an alloy of aluminum.

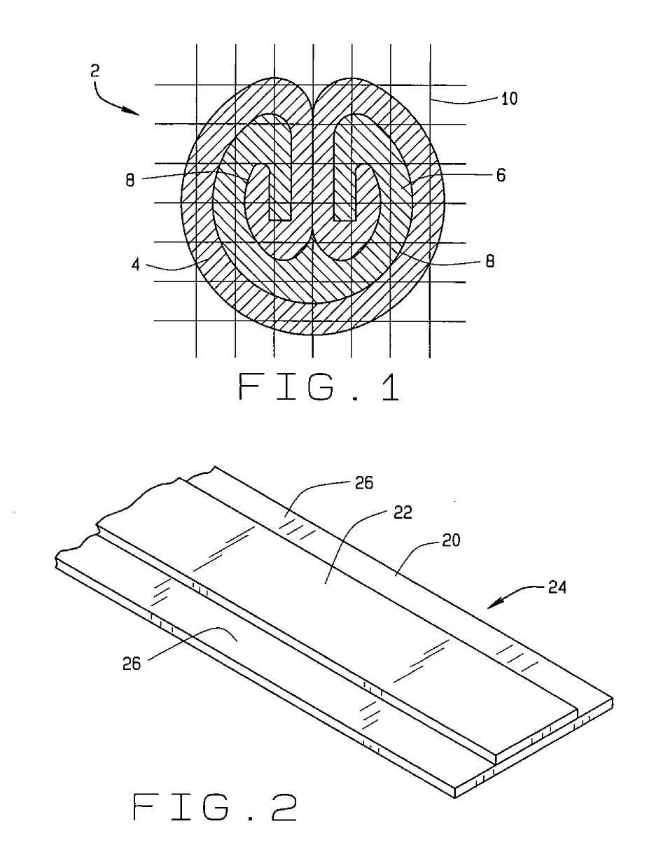

To produce the wire 2, a flat strip 20 of nickel and a flat strip 22 of aluminum, both of equal length, are brought together face-to-face to provide a laminate 24 (FIG. 2). Typically, the aluminum strip 22 will carry an aluminum oxide coating on all of its surfaces owing to the propensity of aluminum to unite with oxygen in the presence of air. That coating prevents the development of a diffusion bond between the two strips 20 and 22. Both strips 20 and 22 should be quite ductile and hence malleable. The width of the nickel strip 20 exceeds the width of the aluminum strip 22, which is centered over the nickel strip 20, leaving two side segments 26 of the nickel strip 20 projecting beyond the side edges of the aluminum strip 22. Even so, the volumetric proportions of nickel and aluminum are the same as that desired for the wire 2.

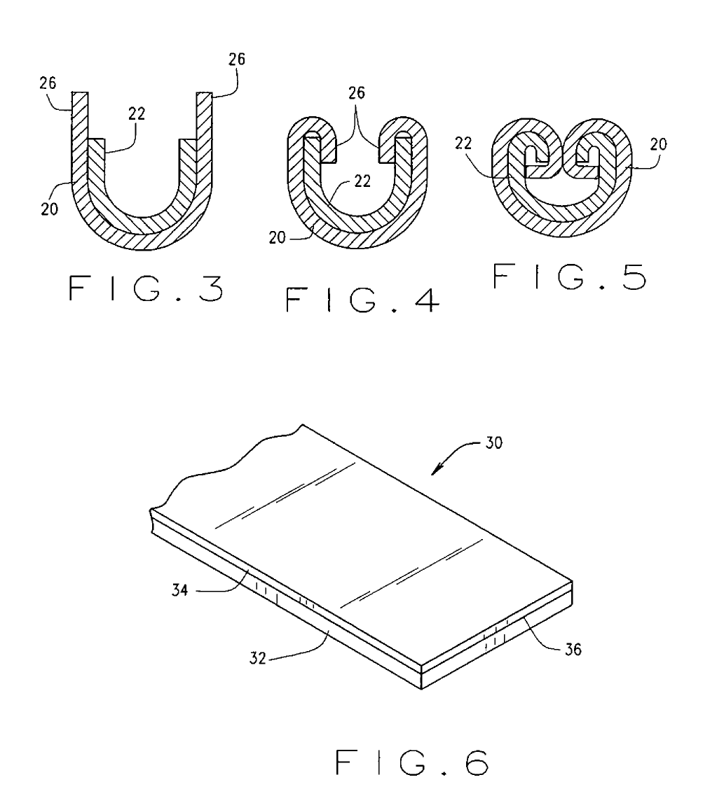

Thereupon, the strips 20 and 22 are rolled into a U-shaped configuration with the narrower aluminum strip 22 being on the inside (FIG. 3). The side segments 26 of the nickel strip 20 continue to project beyond the edges of the aluminum strip 22, but face each other and are generally parallel. Next the side segments 26 are rolled over the edges of the aluminum strip 22 to capture the aluminum strips 22 in the nickel strip 20. The roll forming continues and brings the side segments 26 of the nickel strip 20 against the inside face of the U-shaped aluminum strip 22 (FIG. 4). This locks the two strips 20 and 22 together and produces several convolutions at the interfaces between the strips 20 and 22.

At this juncture, each of the strips 20 and 22 still possess a U-shaped configuration, inasmuch as the free ends of the unbonded laminate 24 are separated. The laminate 24 at its free ends is then rolled or otherwise deformed inwardly so that the end edges on the side segments 26 for the nickel strip 20 come against the inside faces of the U-shaped aluminum strip 22 (FIG. 5). The deformation also turns the aluminum strip 22 over onto itself for a short distance along the free ends of the U-shaped strip 22, that is at the former side edges of the aluminum strip 22. The joined together strips 20 and 22, at this juncture, in cross section possess an enclosed configuration, somewhat cylindrical, on the order of 0.25 to 0.30 inches thick.

Finally, the joined together strips 20 and 22 are drawn through a die or rolled to a lesser diameter—typically 3/32 to ⅛ inch. This consolidates the strips 20 and 22 even further and indeed causes the aluminum from the aluminum strip 22 to flow and fill voids that may otherwise exist in the wire 2 (FIG. 1) that is produced. Thus, the wire 2 has a dense cross-section composed of a nickel component 4 and an aluminum component 6 in face-to-face contact together along a convoluted interface 8 of substantial surface area. The convoluted interface 8 lies not only along the inside surfaces of that portion of the nickel component 4 that forms the exterior of the wire 2, but also throughout the interior of the wire 2. This produces a generally uniform distribution of nickel and aluminum throughout the wire 2 in desired proportions. In other words, the wire 2 has its nickel component 4 and its aluminum component 6 in generally equal ratios throughout the cross-section as reflected in the grid 10 that is superimposed on the wire 2. Moreover, the consolidation in the final draw or roll eliminates any air gaps that previously existed in the cross-section.

As a consequence of the generally uniform distribution, the nickel and aluminum mix well in the heat source into which the wire 2 is fed, and this fosters an exothermic reaction. When the heat source is an arc, that arc attaches generally uniformly across the cross-section, heating the nickel component 4 equally as well as the more conductive aluminum component 6. The coating deposited on a substrate to which the molten constituents are directed contains more nickel aluminide and less free nickel and less free aluminum. Moreover, the surface area of the aluminum component 6, which equals the surface area of the aluminum strip 12 from which the component 6 derives, is considerably less than the surface area of an equivalent amount of aluminum powder. Hence, less aluminum oxide is present to detract from the exothermic reaction and the subsequent quality of the coating.

The aluminum oxide on the aluminum strip 22 produces some aluminum oxide inclusions in the deposited aluminide coating. Usually, these inclusions can be tolerated. Where they cannot, the aluminum strip 22 may be cleaned to remove aluminum oxide from it, and then the procedure for converting the laminate 24 into the wire 2 may be completed in an oxygen free atmosphere, such as an inert gas atmosphere.

An iron strip may be substituted for the nickel strip 20 to produce a wire 2 for depositing iron-aluminide. Also, a titanium strip may be substituted for the nickel strip 20 to produce a wire 2 for depositing titanium-aluminide. Other combinations of metals are possible as well, and they need not be formulated for the production of aluminide coatings. Indeed, some may be formulated for depositing other coatings or for other procedures such as arc welding. Such combinations include nickel and titanium, a nickel-chromium alloy and titanium, a nickel-chromium alloy and aluminum, and nickel and copper, to name a few. Irrespective of the combination of metals, they need not be confined to proportions represented by the limits of alloying such metals. For example, an alloy of nickel and aluminum may have no more than about 10% aluminum by volume. But the nickel-aluminum wire 2 may contain a much higher percentage of aluminum. Where oxide inclusions adversely affect welds, the strips 20 and 22 used in the laminate 24 should be free of oxide coatings.

A bonded laminate 30 (FIG. 6) may be substituted for the unbonded laminate 24. It is derived from a sheet of aluminum-clad nickel having nickel lamina 32 and an aluminum lamina 34, with the two laminae 32 and 34 being diffusion bonded together along an interface 36. The volumetric proportions of the laminae 32 and 34 in the laminate 30 correspond respectively to those desired for the nickel component 4 and the aluminum component 6 in the wire 2. Indeed, the laminate 30 is rolled and drawn into the wire 2 using essentially the same process for converting the unbonded laminate 24 into the wire 2. However, the aluminum lamina 34 being bonded firmly to the nickel lamina 32 need not be initially captured in the nickel lamina 32 by rolling the ends of the nickel lamina 32 over the ends of the aluminum lamina 34. Indeed, the aluminum lamina 34, being as wide as the nickel lamina 32, leaves no side edges 26 on the nickel lamina 32 to roll over into the aluminum lamina 32.

The wire 2 with its convoluted interface 8 may be formed in other cross-sectional configurations, such as elliptical and rectangular, including square.

1. A wire for use as a feedstock in thermal spraying and welding, said wire comprising:
a first metal strip and a second metal strip in face-to-face contact along a convoluted interface that extends throughout the interior of the wire.

2. A wire according to claim 1 wherein the first metal strip forms the exterior surface of the wire.

3. A wire according to claim 2 wherein the first metal strip is greater in cross-sectional area than the second metal strip.

4. A wire according to claim 2 wherein the second metal strip is primarily aluminum.

5. A wire according to claim 4 wherein the first metal strip is primarily nickel.

6. A wire according to claim 4 wherein the first metal strip is primarily iron.

7. A wire according to claim 1 wherein the first metal strip and the second metal strip are distributed in generally uniform proportions throughout the cross-section of the wire.

8. A wire according to claim 1 wherein the first metal strip and the second metal strip are along some of the interface diffusion bonded together.

9. A wire according to claim 1 that is free of internal voids.

10. A wire according to claim 1 wherein the volume of metal in the second metal strip exceeds the volume of that metal that may be alloyed with the metal of the first metal strip.

11. A process for producing a wire for use as a feedstock in thermal spraying and welding, said process comprising:
providing first and second metal strips that are in face-to-face contact;
deforming the face-to-face strips into a U-shaped configuration with the second strip located inside the first strip;
further deforming the strips so that the free ends of the U-shaped configuration turn inwardly toward each other and the strips are together along a convoluted interface; and
thereafter reducing the cross-sectional size of the strips.

12. A process according to claim 11 wherein the first strip is wider than the second strip; and wherein the strips are brought together with side segments of the first strip projecting beyond the side edges of the second strip.

13. The process according to claim 11 wherein the second strip is primarily aluminum.

14. The process according to claim 13 wherein the first strip is primarily nickel.

15. The process according to claim 13 wherein the first strip is primarily iron.

16. The process according to claim 11 wherein the strips are initially separate.

17. The process according to claim 11 wherein the strips are initially diffusion bonded together.

18. The process according to claim 11 wherein the final deforming of the strips is achieved by drawing the already deformed strips through a die.

19. The process according to claim 18 wherein the initial deforming of the strips is achieved by roll forming.
